(19) United States
(12) Patent Application Publication
(10) Pub. No.: US 2010/0153171 A1
(43) Pub. Date: Jun. 17, 2010

(54) METHOD AND APPARATUS FOR FURLOUGH, LEAVE, CLOSURE, SABBATICAL, HOLIDAY, OR VACATION GEO-LOCATION SERVICE

(75) Inventors: George ERHART, LOVELAND, CO (US); Valentine MATULA, GRANVILLE, OH (US); David SKIBA, GOLDEN, CO (US)

Correspondence Address: SHERIDAN ROSS P.C., 1560 BROADWAY, SUITE 1200, DENVER, CO, 80202, US

(73) Assignee: AVAYA, INC., BASKING RIDGE, NJ (US)

(21) Appl. No.: 12/713,512

(22) Filed: Feb. 26, 2010

Related U.S. Application Data
(63) Continuation-in-part of application No. 12/702,764, filed on Feb. 9, 2010.
Application No. 12/702,764 is a continuation-in-part of application No. 12/566,558, filed on Sep. 24, 2009.
Application No. 12/566,558 is a continuation-in-part of application No. 12/561,459, filed on Sep. 17, 2009.
Application No. 12/561,459 is a continuation-in-part of application No. 12/490,247, filed on Jun. 23, 2009.
Application No. 12/490,247 is a continuation-in-part of application No. 12/328,620, filed on Dec. 4, 2008.
Application No. 12/328,620 is a continuation-in-part of application No. 12/242,475, filed on Sep. 30, 2008.
Application No. 12/242,475 is a continuation-in-part of application No. 12/242,005, filed on Sep. 30, 2008.
Application No. 12/242,005 is a continuation-in-part of application No. 12/240,256, filed on Sep. 29, 2008.

(51) Int. Cl. G06Q 10/00

(52) U.S. Cl. 705/9; 705/301

(57) ABSTRACT

An interaction center system allows an enterprise to manage employees based on geo-location information, other characteristics of the employee, and/or company policies. The interaction center system is able to receive geo-location information about a person. The interaction center system can then identify the person and determine a status associated with the person. An exemplary status is any status for the employee while working with the enterprise or not working with the enterprise. For example, the status may be that the employee is on a furlough, is on vacation, is on leave, has been fired, is subject to a lay-off, is on sabbatical, is observing a religious holiday, or some other status associated with the employee. After determining the person and the status associated with the person, the interaction center system may determine an event rule or grammar that affects this person and deals with the status.

### BACKGROUND

Generally, in traditional enterprises and businesses, first level managers are tasked with tracking and managing employees. However, today's businesses and enterprises have flat structures without the hierarchy of older enterprises. Personnel managers are responsible for more employees and more information. To determine what employees need to be working and which employees need to be responsible for what tasks managers must understand, memorize, track, and manage characteristics of both the employees and the work requirements. As the enterprise grows, and the number of employees grows, and the task of managing employees becomes more complicated. Thus, as managers attempt to determine who should working and who should be not be working over holidays, furloughs, leaves, or closures in compliance with labor law, company policy or other requirements, the managers find themselves faced with a very difficult and often unmanageable task.

### SUMMARY

It is with respect to the above issues and other problems that the embodiments presented herein were contemplated. Embodiments of systems and methods are described herein. The embodiments include a system that allows an enterprise to manage employees based on both geo-location information and other characteristics of the employee or company policy. The system is able to receive geo-location information about a person. The system can then identify the person and determine the status of the person, a group of which the person is a member, a facility to which the person is assigned, or a business of which the person is an employee, contractor, etc. A status can be any status of the employee while working with the enterprise or not working with the enterprise. For example, status may include holidays, furlough, vacation, leave, terminated, sabbatical, business closure, shift assignments, weather closures, religious observances, legal or contractual obligations, or some other status of the employee or his employer. After determining the person's location and the status associated with the person, the system may determine an event rule or grammar that affects the person and enforces his associated status.

The system may then apply the event rule or grammar using both the geo-location information and the associated status or other characteristics of that person. To apply the rules, the system is able to determine an action that is associated with that person and adjust the action in accordance with the event rule. Thus, the system enables managers to manage several employees automatically using grammar and geo-location information.

The embodiments use historical information along with a decision support system that receives input from current geo-location events and a grammar to anticipate and select strategies to address the needs of a business regarding employee availability and items of interest to the business. The historical information is commonly strictures of legal, ethical, moral, religion, or the like, of a workforce. The information can also contain the individual and group responsibilities and their availability regarding non-work time, such as holidays, furloughs, leave, closure, labor law or policies, shift assignments, weather closures, sabbaticals, or other legal or contractual obligations. The geo-location information can contain the temporal and geographic information about the workforce and their environs. The grammar can recognize occurrences in the input of current events. The semantics of the grammar offers tokens or tokens representing strategies to the decision support system. The decision support system may use the tokens to select among its own strategies, use the strategies offered by the grammar, modify, or select portions of strategies, or choose its own strategies. The embodiments presented can easily and simply address the needs of the business to enforce and control employee access in accordance with company policies and legal requirements. The embodiments allow geo location input based on grammar matches and, using these inputs, integrates the information with business logic to provide improved enterprise security over the prior art because the embodiments can be applied directly to moving frames of reference. While computerized systems have been build that can codify non-working scheduling issues, a grammar can do this in a more compact and easily maintained and extended form. The embodiments can surpass the prior art by extending location enforcement to arbitrarily complex aggregations of locations, employees, non-employees and items, also known as a carrier, to frames of reference also not well supported by the prior art. The embodiments can surpass geo-fence art because the embodiments use of grammar and multiple grammars predict possible trajectories and therefore motivations. Grammars can also express groups and multi-party interactions very easily through simple, terse, and recursive definitions and have superior pragmatics for pattern recognition by those schooled in the art. Furthermore, motivations can also be deduced from items that individuals and groups may have in their possession. Consequently, geographic and temporal dispersion of workers and items can be more easily handled by the embodiments than in the prior art. The management burden of first level managers of today's flat enterprises can be eased, and, therefore, the business needs of the enterprise are more likely to be met.

A number of examples will illustrate the system's operation. In one example, if a person is subject to a furlough, the person may not be allowed to operate a company vehicle, thus, if the person is attempting to leave a parking lot with a company vehicle, there may be geo-location information locating the person in the parking lot. While the person is trying to leave the gate, the system can determine if the person is on furlough, and trying to leave the parking lot in a company vehicle. With this information, the system can alert security personnel that the person cannot leave the parking lot with the vehicle. In another example, a vehicle, such as airplane, cannot be operated until the entire crew has arrived and supporting gear has been assembled (such as navigation information) and is within the domain of the geo location. In yet another example is that the pairing of an authorized employee accompanied by an employee on furlough would be denied access to a company vehicle because furloughed employees must be excluded from performing any company business to avoid company liability. In another example, a resource is shared among a group of employees such as a laptop, or the like. The laptop may be returned to company property by any individual (e.g., under an amnesty program, promising no prosecution) in a secure corridor (e.g. they can go to security, but not leave company property until they relinquish possession of the laptop), but the laptop may be removed from the company property only by an authorized member of the group of employees. This method is much more flexible than is possible in the prior art, using for example, key cards or biometric data. It can also be done without direct interaction with, for example, a guard so the impersonal nature of the return can make it more palatable to the individual returning the property.

Another simple example is a truck may be disabled (in a safe way) if an unauthorized passenger or a contraband item enters the vehicle. A slightly more complex example is that an employee on vacation (or on business) is headed to a plane to return to critical work, but the flight is delayed. Without further input, this method could result in a backup employee being alerted to cover for the other employee. Another example is that a remote employee whose area is experiencing a weather alert could automatically be covered by another employee not affected by the alert. A more complex example would be that a sudden outflow of workers could be detected at one location, absent any other information. For example, a weather alert or emergency condition could trigger emergency coverage by others employed by the company or perhaps by an outsourced third party. A more complex example is that those religions with strict observance of Sabbath or holiday schedules based on astronomical information could be more conveniently-served and business needs met more precisely at the same time. One example is that such an observant individual could work right up to the moment of “sundown” (as defined by religious text) and then their work-related equipment could be automatically disabled. Even more advanced strategies applied to complex aggregates of people, items, business logic, or the like, may be envisioned by those schooled in the art.

The phrases “at least one”, “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine”, “calculate” and “compute,” and variations thereof, as used herein, are used interchangeably and include any type of methodology, process, mathematical operation, or technique.

Herein, a person or object may be identified in various ways. For example, the identification may be indirect, for instance, from a guard entering an employee identifier number. Identification may be direct from the receipt of personal identifiers, such as keycard scans, biometric scans, login, radio frequency identity card interactions, etc. Further, identification may be determined through relationships, such as, an object (cell phone, truck, geo-pod, computer, etc.) being linked to a person or other object.

The term “module” refers to any known or later developed hardware, software, firmware, artificial intelligence, fuzzy logic, or combination of hardware and software that is capable of performing the functionality associated with that element. Also, while exemplary embodiments have been described, it should be appreciated that aspects of the embodiments can be separately claimed.

The preceding is a simplified summary of some embodiments to provide an understanding of some aspects of the embodiments. This summary is neither an extensive nor exhaustive overview of the various embodiments. It is intended neither to identify key or critical elements nor to delineate the scope of the claims but to present selected concepts of the embodiments in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram of an embodiment of an interaction center system operable to manage employees and conduct actions using geo-location information and other enterprise data;

FIG. 2 is a block diagram of an embodiment of an interaction center server operable to conduct actions in response to events associated with geo-location information;

FIGS. 3A-3C are block diagrams of embodiments of data structures that may be sent, received, or stored while trying to manage and conduct actions associated with employees having associated geo-location information;

FIG. 4 is a flow diagram of an embodiment of a process for determining a rule associated with a person having status, applying the rule, and conducting an action in response to applying the rule;

FIG. 5 is another flow diagram of an embodiment of a process for determining a rule to apply to a person associated with geo-location information;

FIG. 6 is a block diagram of an embodiment of a computer environment that may be executed with respect to the components and systems of the embodiments presented herein; and

FIG. 7 is a block diagram of a computer, which may be the same or similar to the servers, computers, devices, and/or components described herein.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only and is not intended to limit the scope, applicability, or configuration of the embodiments. Rather, the ensuing description will provide those skilled in the art with an enabling description for implementing the embodiments. Various changes may be made in the function and arrangement of elements without departing from the spirit and scope of the appended claims.

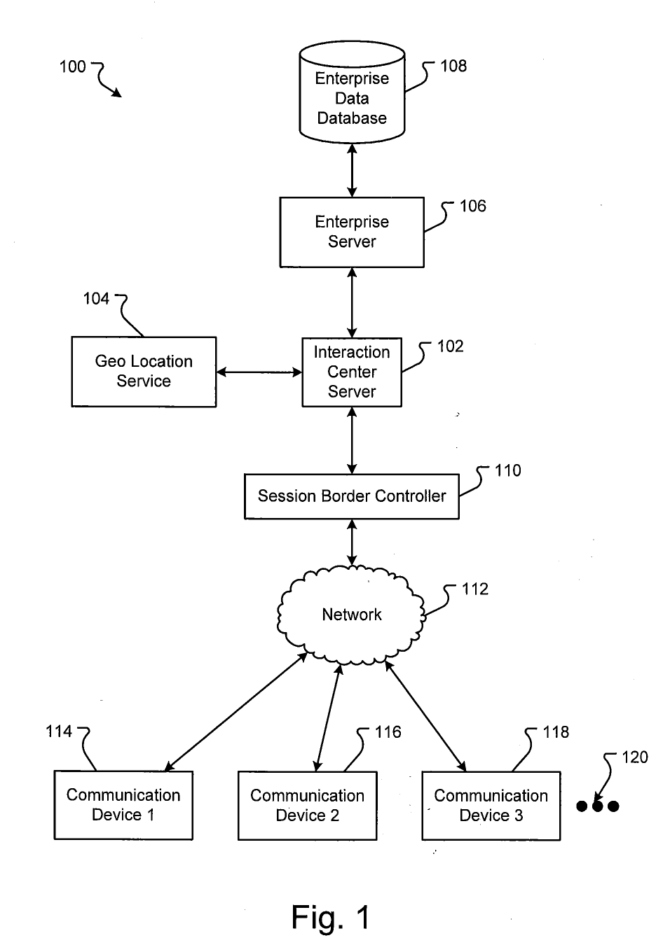

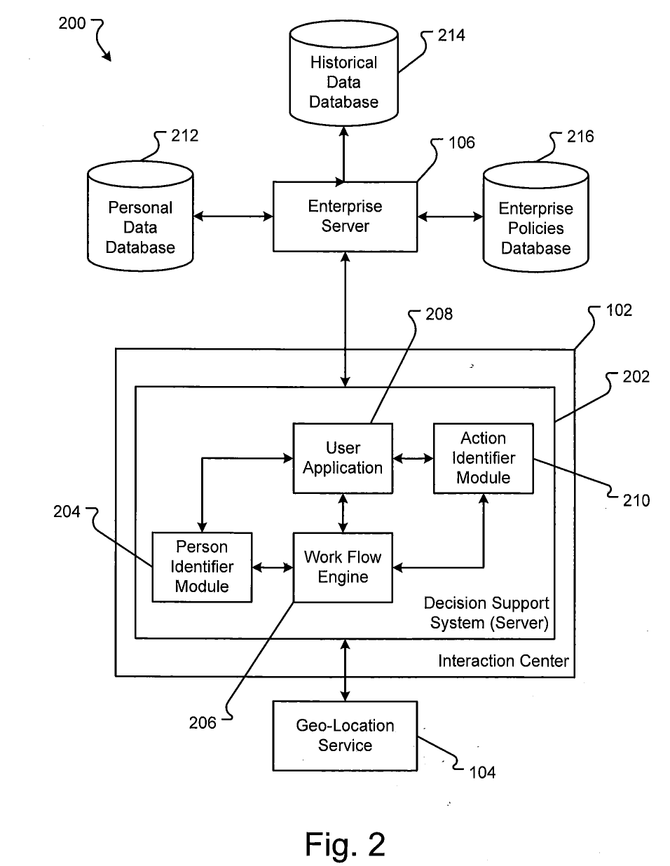

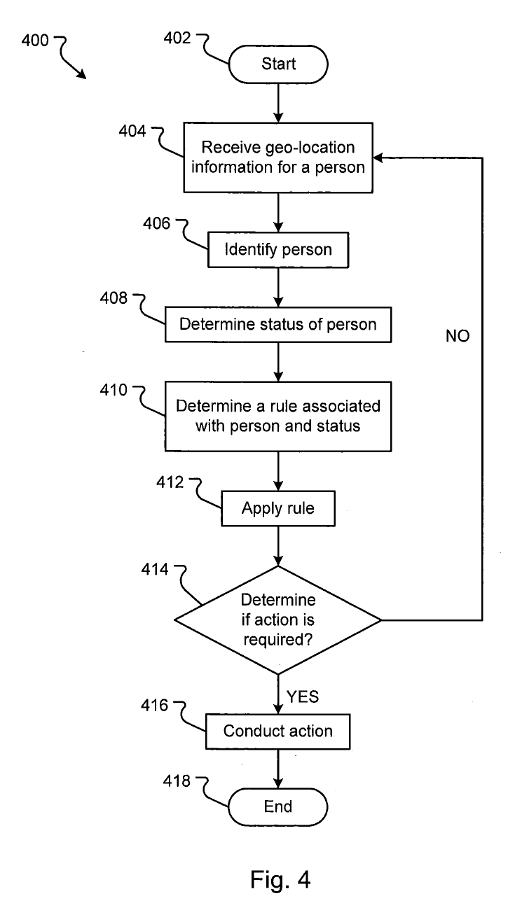

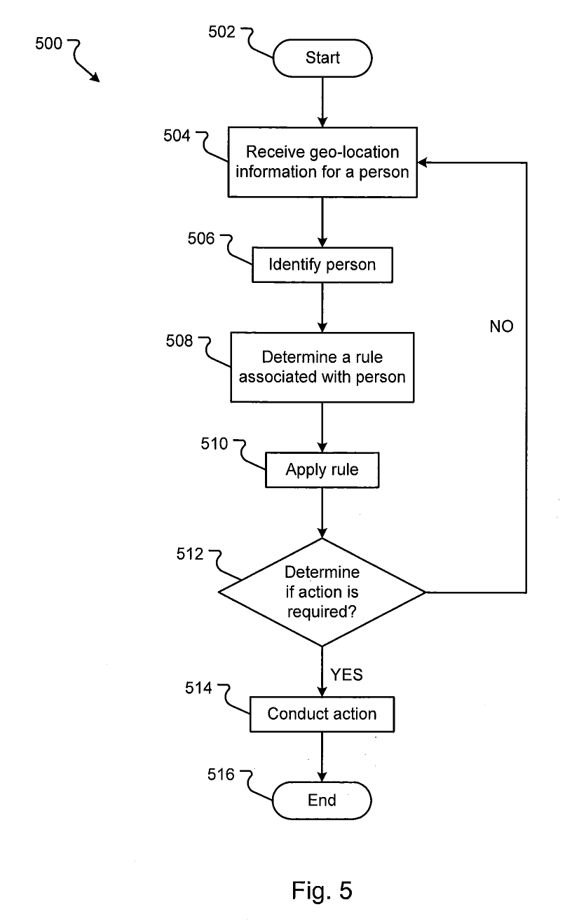

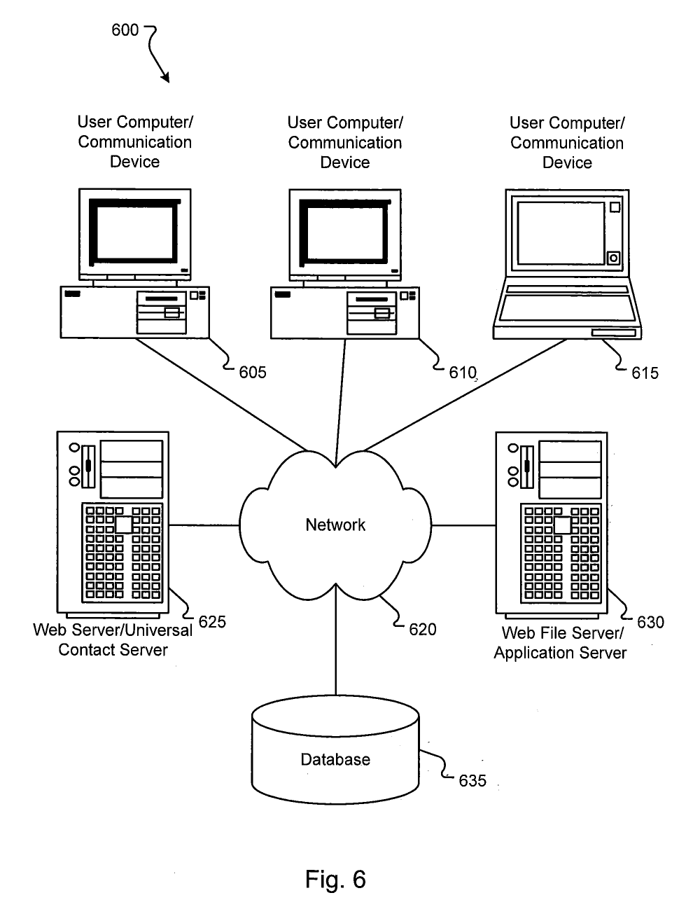

An embodiment of an interaction center system 100, for managing information about customers associated with an enterprise, is shown in FIG. 1. The components and systems described in FIG. 1, and the other figures presented hereinafter, can include computer systems, or other hardware, software, or combinations of hardware and software to execute the functions as described herein. The devices and systems described in FIGS. 1 and 2 can execute the processes described in FIG. 4. Further, the systems and components can be executed in a computer system, as described in conjunction with FIGS. 5 and 6, as software modules or computer executable instructions. The systems and devices may also represent hardware wherein the functions are coded in a logic circuit, such as an application specific integrated circuit (ASIC) or a field programmable gate array (FPGA). Herein the devices and components will be described by their function.

The interaction center system 100 can include an interaction center server 102, wherein the interaction center server 102 is operable to manage information availability. An embodiment of the interaction center server 102 is described in conjunction with FIG. 2. The interaction center server 102 is in communication with an enterprise server 106 and a geo-location service 104. Throughout the description, the term “in communication with” is used to describe any electrical, light, or other signal coupling between two or more components, wherein the exchange of electrical signals may be by any protocol or format regardless of whether the physical connection is wired or wireless. The interaction center server 102 is operable to receive data from both the enterprise server 106 and the geo-location service 104 to manage information associated with a person that is interacting with an enterprise.

The enterprise server 106 is operable to both manage and store data for an enterprise. An enterprise can be any enterprise or business that may employ the interaction center server 102. An enterprise server 106 stores data in an enterprise data database 108. The enterprise data database 108 can be any hardware and/or software operable to store data. For example, the enterprise data database 108 may be a data storage system executing a database application operable to store data in any type of database, as described in conjunction with FIG. 5. The enterprise data database 108 stores data about persons associated with the enterprise, about the relationships between the enterprise and the people, and other information. Data about objects, such as vehicles, computers, or other property either owned or operated by the enterprise, may also be stored in the enterprise data database 108. Other data, associated with other functions of the enterprise, may be also stored in the enterprise data database 108. The enterprise server 106 is operable to receive information from the interaction center server 102 to determine associated data within the enterprise data database 108. The enterprise data may be retrieved and sent back to the interaction center server 102.

The geo-location service 104 is operable to receive and/or provide geo-location information to the interaction center server 102. The geo-location service 104 may be part of the interaction center system 100 and included with the interaction center server 102 or may be a third-party service that provides geo-location information. The geo-location service 104 can receive geo-location information from one or more sources. For example, the geo-location service 104 can receive geo-location information from a GPS device embedded within a communication device used and carried by a person. In other embodiments, the geo-location service 104 can receive geo-location information from a radio frequency identifier reader that is able to receive signals from an RFID card carried by a person. One or more other sources may be able to generally identify a location for a person and provide the information to the geo-location service 104. The geo-location information may then be integrated with the identity of the person, and sent by the geo-location service 104 to the interaction center server 102. As such, the interaction center server 102 can receive geo-location information for one or more persons associated with the enterprise. An additional source of geo-location information can include social media networks (e.g., Twitter bundles location information with entries posted by the user). The geo-location service 104 can monitor such social media sources and extract the location information. Likewise, it may be possible to acquire location information via other services, such as, Google Latitude.

The interaction center system 100 may also include a session border controller 110. A session border controller 110 functions as an interface between the interaction center server 102 and one or more communication devices, such as communication device 1 114, communication device 2 116, and/or communication device 3 118. The session border controller 110 is operable to communicate in any protocol or format across any type of network 112 to any type of communication device 114, 116, and/or 118. As such, the session border controller 110 is operable to send and receive messages over email, over a plain old telephone system (POTS), over cellular phone systems, through computer networks, or over any other type of communication media. As such, the network 112 may be any type of network that allows the session border controller 110, to communicate with the communication devices 114, 116, and/or 118. The communication devices 114, 116, and/or 118 likewise may be any type of communication devices including: mobile telephones, laptop computers, desktop computers, servers, thin client applications executing on computer systems, private branch exchanges having telephones that may be using session initiation protocol or other types of communication protocols, or other types of communication devices. There may be more or fewer types of communication devices than those shown in FIG. 1, as represented by the ellipses 120.

Another embodiment of the interaction center system 100, showing more detail for the interaction center server 102, is shown in FIG. 2. The interaction center server 102 includes a decision support system 202, which may be executed as a server or other computer system within the interaction center system 100. The decision support system 202 is operable to determine information about a user, apply event rules or business grammar, and determine information to present. The decision support system 202 can function as a management system that can automatically react to events involving one or more persons associated with the enterprise. To react to these events, the decision support system 202 can conduct actions. These actions may include modifying information presented to an enterprise.

The decision support system 202 can include a person identifier module 204, a work flow engine 206, and/or a user application 208. The person identifier module 204 can be operable to receive geo-location information from a geo-location service 104. From the geo-location information, the person identifier module 204 can extract an identity of a person or an object that is associated with the geo-location information. For example, the person identifier module 204 can locate a person's name, a person's cell phone, a person's address, an object's identity, or some other information included with the geo-location information that identifies the person or object. The identifier or identity of the person or object may be sent by the person identifier module 204 to the user application 208 or the work flow engine 206. An object can be any type of property owned or operated by the enterprise. For example, an object can be a truck, a mobile phone, a computer, inventory, and/or other item. The systems and methods described hereinafter can apply to objects or persons.

The action identifier module 210 is operable to determine an action that must be conducted in response to an event. For example, the action may include denying a person access to a location associated with an enterprise, denying a person access to a system associated with an enterprise, denying a person operation of a system, denying a person the ability to accept responsibility for a system or object associated with an enterprise, disabling a device or object, denying operation of a system located at a certain predetermined location, sending a message to a second person to respond to a status associated with the first person, or alerting the person of an obligation that they are required to perform. There may be other actions that the action identifier module 210 can determine as one skilled in the art will understand. The action identifier module 210 is operable to identify the action based on the result of applying a rule to information received by the decision support system 202. The action may be sent to either the user application 208 and/or the work flow engine 206 in order to conduct the action.

The user application 208 may be a user created module that is operable to determine applicable event rules or grammar that should be applied to an event associated with the person or object. The user application 208 can communicate with the enterprise server 106. From the enterprise server 106, the user application 208 can receive information about persons, information about the enterprise or event, or historical data that can be used to both determine an event rule or business grammar associated with the person and information to input into the event rule. In some situations, the user application 208 can also apply the event rule in order to determine if an action needs to be identified by the action identifier module 210. If an action needs to be conducted, the user application 208 can send the result of the applied rule to the work flow engine 206. From there, the work flow engine 206 can retrieve the action to be conducted from the action identifier module 210.

A work flow engine 206 can complete or conduct the same operation(s) as the user application 208 or may complete other processes. For example, the work flow engine 206 may receive the action from the action identifier module 210. From the action identified, the work flow engine 206 can determine a response to the action. Thus, the work flow engine 206 can conduct the action by changing information, other messages to the enterprise. As such, the work flow engine 206 conducts the action identified by the action identifier module 210. In alternative embodiments, the decision support system 202 is executed by an enterprise server 106.

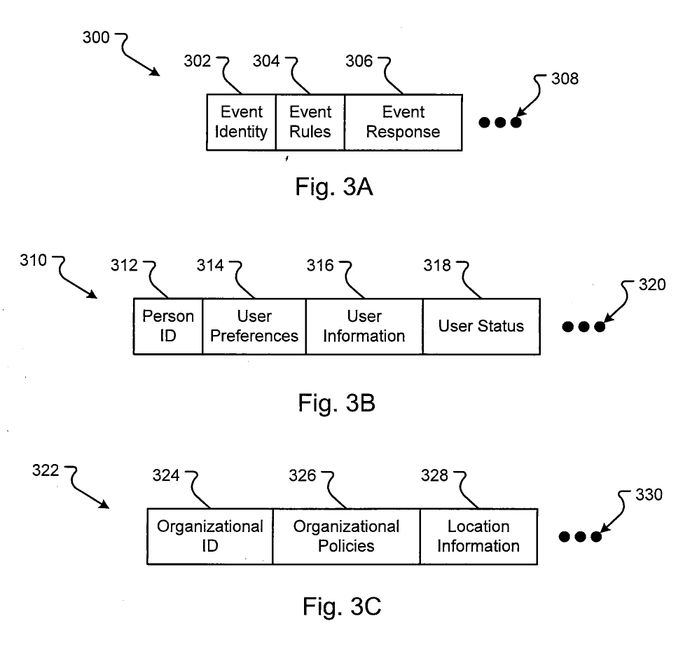

The enterprise server 106 can store and retrieve enterprise data from an enterprise data database 108, as explained in conjunction with FIG. 1. The enterprise data database 108 is separated into three different databases. The databases may include a personal data database 212, a historical data database 214, and an enterprise policies database 216. The personal data database 212 can store information about one or more persons or one or more objects associated with the enterprise. The data stored, about the people or objects associated with the enterprise, is described in conjunction with FIG. 3B. The personal data may be modified or input by both the enterprise and the person that is associated with the personal data.

The enterprise server 106 may also store and retrieve enterprise policies or grammar from an enterprise policies database 216. The data stored by the enterprise policies database 216 may be as described in conjunction with FIG. 3A and/or FIG. 3C. The enterprise policies database 216 can include a grammar that is associated with events in which the enterprise is interested. A “grammar” is a set of heuristics or rules that can be applied to certain input data. For example, a grammar can determine if an event has occurred by inputting the identity of the person involved and one or more items of geo-location information. The grammar is described as enterprise policies or business policy rules that can be set by the enterprise server 106 and applied by the decision support system 202. In other embodiments, the decision support system 202 sends information to the enterprise server 106 to determine what rules apply. Once one or more rules have been determined to apply to an event, the enterprise server 106 may then send that rule or set of rules back to the decision support system 202 for application of the rule(s).

The enterprise server 106 may also store historical data in the historical data database 214. Historical data database 214 may include information about actions or events associated with one or more persons. For example, the historical data database 214 may include previous interactions with the person. As such, the enterprise server 106 can determine when a person is likely conducting a new action. The historical data database 214 may be provided by the enterprise server 106 to a decision support system 202 to better apply event rules and to forecast events into the future, to forecast a possible location for a person, or forecast a trajectory for a person.

An embodiment of the event data structure 300, as stored within the enterprise policies database 216, is shown in FIG. 3A. The event data structure 300 may be stored, sent, or received by an enterprise policies database 216. The event data structure 300 includes an event identity field 302, an event rules field 304, and an event response field 306. The event data structure 300 may have more or fewer fields than those shown in FIG. 3, as represented by the ellipses 308. Generally, the numeric identifiers and names in FIG. 3A both represent the field and the data stored within the field.

The event identity field 302 includes an identity for an event that is associated with a business policy rule. The event identity 302 could be a globally unique identifier (GUID) or some other identifier. In other embodiments, the event identity 302 includes one or more characteristics that are associated with the rule. For example, the event identity 302 can include the inputs required to enact a rule. For instance, the inputs may include personnel identities, associated status associated with the persons, the type of employee, or other information that are characteristics of a group of persons that are associated with the enterprise. The inputs may also be other inputs that may relate the rule to one or more inputs occurring during a period of time.

The event rules data field 304 includes one or more business policy rules that are associated with an event. The event rules data field 304 can include an event rule that is created by the enterprise. There may be one or more rules associated with each event identity 302. Two or more people can be associated together in what is called a “Geo-Pod.” A “Geo-Pod” is a frame of reference that may include people, objects, locations, or other characteristics that provide a frame of reference. One or more event rules 304 may be applied to each Geo-Pod.

The event data structure 300 also includes an event response 306. The event response 306 can be any action that needs to be taken by the interaction center server 102 in response to applying an event rule 304. An event response 306 may also include possible outcomes from applying a rule or an associated response that needs to be conducted.

Referring to FIG. 3B, data structure 310 includes personal data or data about objects, as stored in the personal data database 212. The personal data database 212 may receive, store, or send one or more portions of the data structures 310 in response to interactions with the enterprise server 106. The data structure 310 may include one or more fields. Each field may have a number and an identifier, which both describe the field and the data within the field, as stored in the data structure 310. The data structure 310 may have more or fewer fields than those shown in FIG. 3B, as represented by ellipses 320. The data structure 310 can include a person identifier (ID) field 312, user preferences field 314, user information field 316, and a user status field 318. The person ID field 312 includes an ID for a person. This person ID 312 can be a globally unique identifier (GUID) or some other numeric or alphanumeric identifier for the employee or object. In other embodiments, the person ID 312 includes a name, a cell phone number, an address, or some other characteristic specific to a person or object. The persons or objects associated with data structure 310 have a relationship with the enterprise or organization. For example, the person may be an employee, an independent contractor, a former employee, or some other type of person that is employed or in a relationship, which lasts over a period of time, with the enterprise. The person ID 312 can be used by the person identifier module 204 to identify geo-location information associated with that person or object.

The data structure 310 can also include a user preferences field 314. User preferences field 314 can include one or more settings that may be provided or applied by the person. For example, the user preferences 314 can include a preferred religion, a family description, or other information that may be related to the availability of that employee to work on certain days or times. The user preferences 314 may be used to apply the event rule 304.

User information 316 can also include characteristics about the employee, object, or other person associated with the enterprise. User information 316 can be public information or information that the enterprise is able to discern or retrieve from interaction(s) with the person or from other sources. For example, user information 316 can include the person's name, address, phone number, their working hours, their job description, or other information associated with the person and accessible to the enterprise. User information 316 may include object information, such as the type of object (computer, car, etc.), the characteristics of the object (make, model, serial number, etc.), and other information. Further, user information 316 may also include associations between persons and objects. For example, a person may use a laptop computer. The user information 316 can include an association between the person and the laptop. Further, objects may be associated with other elements, such as locations.

A user status 318 includes the status associated with the user at any given period of time. Thus, the user status 318 can be dynamic and change over time. The user status 318 may include statuses consisting from furlough, leave, closure, sabbatical, holiday, or vacation. Thus, when a user leaves for vacation, the user status 318 goes from working to vacation. As such, the enterprise server 106 is aware of the status associated with the user at any given point of time. With the user status 318 being stored, the enterprise server 106 can automatically apply the event rule(s) 304 applicable to different employees based upon their user status 318.

An embodiment of an enterprise policies data structure 322, which can be stored in an enterprise policies database 216, is shown in FIG. 3C. The enterprise policies database 216 can include information about the enterprise or different information about characteristics or objects associated with the enterprise. The enterprise policies data structure 322 can include more or fewer fields than those shown in FIG. 3C as represented by ellipses 330. The enterprise policies data structure 322 includes an enterprise identifier (ID) field 324, an enterprise policies field 326, and/or a location information field 328.

The organizational ID 324 can be a GUID, a name of the enterprise, or some other identifier that uniquely identifies the enterprise. The organizational ID 324 may be associated with one or more organizational policies 326. An organizational policy 326 may be a general guideline that applies to the enterprise or to one or more events associated with the enterprise. The organizational policy 326 may include one or more rules, such as the event rules 304, described in conjunction with FIG. 3A. Each enterprise may have one or more organization(s) and thus include one or more organizational identifiers 324. Further, each enterprise may have one or more organizational policies 326 associated with each organizational ID 324.

The enterprise policies data structure 322 can also include location information 328. Some organizational policies 326 or event rules 304 may be associated with physical locations (e.g., buildings) or with objects or items that the enterprise operates or owns. For example, one event rule 304 may apply to a manufacturing facility. Likewise, an organizational policy 326 may apply to an automobile that is used by one or more employees. As such, the location information 328 for these different locations or objects is stored in the location information field 328.

An embodiment of a process for managing events associated with geo-location information is shown in FIG. 4. Generally, the method 400 begins with a start operation 402 and terminates with an end operation 418. While a general order for the steps of the method 400 are shown in FIG. 4, the method 400 can include more or fewer steps or arrange the order of the steps differently than those shown in FIG. 4. The method 400 can be executed as a set of computer-executable instructions executed by a computer system and encoded or stored on a computer readable medium. Hereinafter, the method 400 shall be explained with reference to the systems, components, modules, software, data structures, etc. described in conjunction with FIGS. 1-7.

The decision support system 202 of the interaction center server 102 receives geo-location information for a first person of first object from a geo-location service 104, in step 404. The geo-location information is sent periodically. For example, geo-location information for a person or an object may be sent every minute or every hour. The geo-location information can include a location for the person or the object and an identifier for that person or object. The geo-location information can then be sent to a person identifier module 204. The person identifier module 204 can identify the person or object, in step 406. The person identifier module 204 looks for a name, a cell phone number, an address, or other information that identifies the person or object in the geo-location information. Once the person or object is identified, the person identifier module 204 sends the identity to the work flow engine 206 and/or the user application 208. The identity may also be sent from the user application 208 and/or work flow engine 206 to the enterprise server 106.

The enterprise server 106 can then determine the status associated with the person or object, in step 408. The enterprise server 106 searches for the person or object identity in the personal data database 212. Thus, the enterprise server 106 searches for a match of the person ID and the person ID field 312 of the data structure 310. Upon finding the person ID 312, the enterprise server 106 can retrieve the user status 318 from the data structure 310.

With the geo-location information and/or the user status 318, the enterprise server 106 may then search one or more event data structures 300 for an event identity 302 that applies both to the person or object and to the other characteristics of the event, in step 410. The enterprise server 106 searches for an event rule 304 that is associated with the person ID 312 and the user status 318. Upon finding one or more of the event identities 302 that match the person ID 312 and the user status 318, the enterprise server 106 reads the event rule 304 and the event response 306 and sends the information to the decision support system 202.

Upon receiving the event rule 304 and the event response 306, the decision support system 202 can apply the rule, in step 412. Applying the rule requires the decision support system 202 to apply logic or other heuristic rule with the information either known by the decision support system 202 or provided by the enterprise server 106. Thus, the decision support system 202 may receive one or more items of information from the personal data database 212 as sent by the enterprise server 106. Further, the decision support system 202 may receive historical data from the historical data database 214 or information from the enterprise policies database 216. For example, a decision support system 202 may receive user preferences 314, user information 316, user status 318, enterprise policies 326, and/or location information 328. The decision support system 202 may then insert the items of information and the user status 318 for the person or object into the rule algorithm. After inserting the information into the rule, the decision support system 202 then can calculate an outcome for the rule. The rule may also require information about a second person or object. The information about the second person or object may be included with the information about the first person or object to determine an outcome to the rule. The first and second person or object may be members of a Geo-Pod. Part of the information that may be required for the second person or object is the status associated with the second person or object.

Depending upon the event response 306 and the outcome of the rule determination by the decision support system 202, the decision support system 202 may determine if an action is required, in step 414. The work flow engine 206 and/or the user application 208 may apply the rule. The results of the rule may be sent to an action identifier module 210. The action identifier module 210 can determine the outcome of the event rule 304 and the appropriate event response 306. If an action is required, the method 400 flows “YES” to step 416. In contrast, if an action is not required, the method 400 flows “NO” back to step 404. If an action is required, the action identifier module 210 can determine the appropriate response required for the decision support system 202. The work flow engine 206 can send an indication or other signal to one or more processes or entities to conduct the action(s), in step 416. The indication may even be sent to work flow engine 206 itself to conduct the action(s). As an example, the action may be denying a person access to a location associated with an enterprise, disabling a device or object, denying a person access to a system associated with an enterprise, denying a person the operation of a system associated with an enterprise, denying a person operation of a system without another person also located at the location, sending a message to at least the second person to respond to the status associated with the first person, or alerting the first person of an obligation. In other examples, the action may require another person to assume the duties of a first person for a period of time, another person to wait for a first person at a location before conducting another action, another person to respond to an alert caused by a first person, a person to retrieve an item of property associated with the first person, or a second person to locate the first person to provide assistance. If the rule applied information from a first and second person, the action may require involvement of a third person. The work flow engine 206 may then send communications to one or more communication devices 114, 116, and/or 118 to effect the action.

An embodiment of a method 500, for managing events dealing with persons or objects associated with an enterprise is shown in FIG. 5. Generally, the method 500 begins with a start operation 502 and terminates with an end operation 516. While a general order for the steps of the method 500 are shown in FIG. 5, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, components, modules, software, data structures, etc. described in conjunction with FIGS. 1-3C.

The person identifier module 204 of the decision support system 202 receives geo-location information associated with a person or object, in step 504. As with operation 404 of FIG. 4, the person identifier module 204 identifies the person or object, in step 506. The identity is then sent to the work flow engine 206 and/or user application 208. The user application 208 and/or work flow engine 206 sends the identity to the enterprise server 106.

In contrast to the method 400 in FIG. 4, the enterprise server 106 searches the enterprise policies database 216 for an event that is only associated with this person or object. The enterprise server 106 searches for an event identity 302 that includes the person or object. The person identity may be an identity for a group of people. For example, the identity may be of a group of people that work in a certain location, wherein that location was closed. As such, any person or object having that group identity would have a rule that prohibits them from working.

The enterprise server 106 determines a rule associated with the person or object, in step 508. This rule may then be sent back to the user application 208 and/or work flow engine 206 of the decision support system 202, to apply the rule. The user application 208 can apply the rule, in step 510. Similar to step 412 of FIG. 4, the user application 208 determines whether or not the rule requires a response. Thus, the user application 208 determines if an action is required by the decision support system 202, in step 512. If an action is required, the method 500 flows “YES” to step 514. If no action is required, the method 500 flows “NO” back to step 504.

The outcome of the rule is sent to the action identifier module 210. The action identifier module 210 determines actions that should be applied by the work flow engine 206. These actions are sent to the work flow engine 206, and the work flow engine 206 conducts the action(s), in step 514.

### EXAMPLES

The interaction center system 100, described herein can be used in various ways. Several examples are hereinafter provided to show the flexibility of the interaction center system 100. In one example, an employee who is on furlough tries to access a company vehicle. The company vehicle is in a parking lot at an enterprise location. When the person tries to access the parking lot, the identity of the employee is provided to a parking lot attendant. The interaction center server 102 can receive the identity of the employee and also receive geo-location information for the employee from the geo-location service 104. The interaction center server 102 then interacts with the enterprise server 106 to determine the status associated with the employee. The enterprise server 106 can return a status “on furlough” to the interaction center server 102. Using this information, the interaction center server 102 can send a message back to the parking lot attendant using communication device 1 114, that the employee cannot access the vehicle.

In another example, several employees may share a single laptop. However, one of the employees may be using the laptop and then be subject to a lay-off. This laptop, which is company property, can be returned by the individual. However, the property needs to be returned in a certain location, such as, a secured corridor or a security desk. The interaction center server 102 can receive geo-location information for both the person and the laptop. The interaction center server 102 can request information about the employer from the enterprise server 106. The enterprise server 106 can alert the interaction center server 102 that the person has been laid-off and is no longer employed by the company. As such, the interaction center server 102 can send an alert message to a communication device 2 116 at a security checkpoint that the employee is carrying the laptop, which needs to be returned. In this way, the security personnel are automatically informed of the unauthorized possession of the laptop by the employee who is no longer employed by the enterprise.

An employee, in another example, may be using a company truck for company business. However, the employee may bring a contraband item from the company into the company vehicle. For example, the person may be leaving with a piece of equipment, and the interaction center server 102 can receive geo-location information from the geo-location service 104 for this piece of equipment. When the employee tries to take the piece of equipment out of a certain area, the interaction center server 102 can alert a security checkpoint that the employee needs to be stopped.

In yet another example, there may need to be several employees present for the occurrence of an event. For example, before an airplane can take off, the entire crew needs to be at the airport and assembled to fly the plane. The interaction center server 102 can receive geo-location information for all of the flight crew members, such as, the two pilots. If one of the pilots is not at the airport, the interaction center server 102 can alert ground personnel at the airport, using communication device 3 118, that the airplane cannot take off because of the absence of one of the employees.

In still another example, the interaction center server 102 may receive weather data or be aware of a weather emergency at an enterprise location. The interaction center server 102 receives geo-location information for several employees at the enterprise facility. This geo-location information can indicate that the employees are not at the workplace, but at home because they are unable to commute into their office. The interaction center server 102 can then send an alert to a manager that employees at a different enterprise facility need to cover for the employees that are affected by the weather emergency.

The interaction center server 102, in another example, can receive geo-location information for one or more people who are leaving a facility rapidly. For example, if a facility has caught fire and there is a mass evacuation, the interaction center server 102 will find that the geo-location information indicates that there is a mass exodus from the facility. As such, the interaction center server 102 can also alert other employees through several different communication devices 114, 116, and/or 118 that they also need to evacuate the facility.

A business may also need to implement a “firewall” between two or more groups of employees. For example, in a financial services organization, a business is required to separate independent analysts from stock brokers. The system could track spatial separation between the persons associated with these classes of employees. Thus, interactions between the firewalled people can be monitored or controlled.

Still further, event rules may also cover cases where there has not been a geo-location update for an employee for some period of time. When the update does not change location for a period of time (e.g., has not moved for a week), or when there are conflicting location updates (e.g., the phone GPS is from one location while the RFID badge tags them at a different location), the system can alert security, law enforcement, or emergency services of a possible problem with the person (e.g., the person needs medical attention).

As a final example, the interaction center server 102 can receive information about an employee's religious requirements from the enterprise server 106. For example, the Sabbath for the Jewish religion occurs on sundown on Friday. In order that the employees may be able to leave and proper coverage is maintained for an office, the interaction center server 102 may obtain geo-location information for those employees. At sundown, the interaction center server 102 can alert the employees that they are required or need to leave to observe their religious requirements. Further, other employees may be alerted that they need to cover for these employees who left to observe their religious doctrine.

FIG. 6 illustrates a block diagram of a system 600 that may function as servers, computers, or other systems provided herein. The system 600 includes one or more user computers 605, 610, and 615. The user computers 605, 610, and 615 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 605, 610, 615 may also have any of a variety of applications, including for example, database client and/or server applications, and web browser applications. Alternatively, the user computers 605, 610, and 615 may be any other electronic device, such as a thin-client computer, Internet-enabled mobile telephone, other mobile devices, and/or personal digital assistant, capable of communicating via a network (e.g., the network 620 described below), displaying and navigating web pages, and/or completing other functionality. Although the exemplary system 600 is shown with three user computers, any number of user computers may be supported.

System 600 further includes a network 620. The network 620 may can be any type of network familiar to those skilled in the art that can support data communications using any of a variety of commercially-available protocols, including without limitation SIP, TCP/IP, SNA, IPX, AppleTalk, and the like. Merely by way of example, the network 620 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 602.11 suite of protocols, the Bluetooth™ protocol known in the art, and/or any other wireless protocol); and/or any combination of these and/or other networks.

The system may also include one or more server computers 625, 630. One server may be a web server 625, which may be used to process requests for web pages or other electronic documents from user computers 605, 610, and 620. The web server can be running an operating system including any of those discussed above, as well as any commercially-available server operating systems. The web server 625 can also run a variety of server applications, including SIP servers, HTTP servers, FTP servers, CGI servers, database servers, Java servers, and the like. In some instances, the web server 625 may publish operations available operations as one or more web services.

The system 600 may also include one or more web file and or/application servers 630, which can, in addition to an operating system, include one or more applications accessible by a client running on one or more of the user computers 605, 610, 615. The server(s) 630 may be one or more general purpose computers capable of executing programs or scripts in response to the user computers 605, 610 and 615. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 630 may also include database servers, including without limitation those commercially available from Oracle, Microsoft, Sybase™, IBM™ and the like, which can process requests from database clients running on a user computer 605.

The web pages created by the web application server 630 may be forwarded to a user computer 605 via a web server 625. Similarly, the web server 625 may be able to receive web page requests, web services invocations, and/or input data from a user computer 605 and can forward the web page requests and/or input data to the web application server 630. In further embodiments, the web server 630 may function as a file server. Although for ease of description, FIG. 6 illustrates a separate web server 625 and file/application server 630, those skilled in the art will recognize that the functions described with respect to servers 625, 630 may be performed by a single server and/or a plurality of specialized servers, depending on implementation-specific needs and parameters. The computer systems 605, 610, and 615, file server 625 and/or application server 630 may function as the devices, components, and/or systems described herein.

The system 600 may also include a database 635. The database 635 may reside in a variety of locations. By way of example, database 635 may reside on a storage medium local to (and/or resident in) one or more of the computers 605, 610, 615, 625, 630. Alternatively, it may be remote from any or all of the computers 605, 610, 615, 625, 630, and in communication (e.g., via the network 620) with one or more of these. In a particular set of embodiments, the database 635 may reside in a storage-area network (“SAN”) familiar to those skilled in the art. Similarly, any necessary files for performing the functions attributed to the computers 605, 610, 615, 625, 630 may be stored locally on the respective computer and/or remotely, as appropriate. In one set of embodiments, the database 635 may be a relational database, such as Oracle 10i™, that is adapted to store, update, and retrieve data in response to SQL-formatted commands.

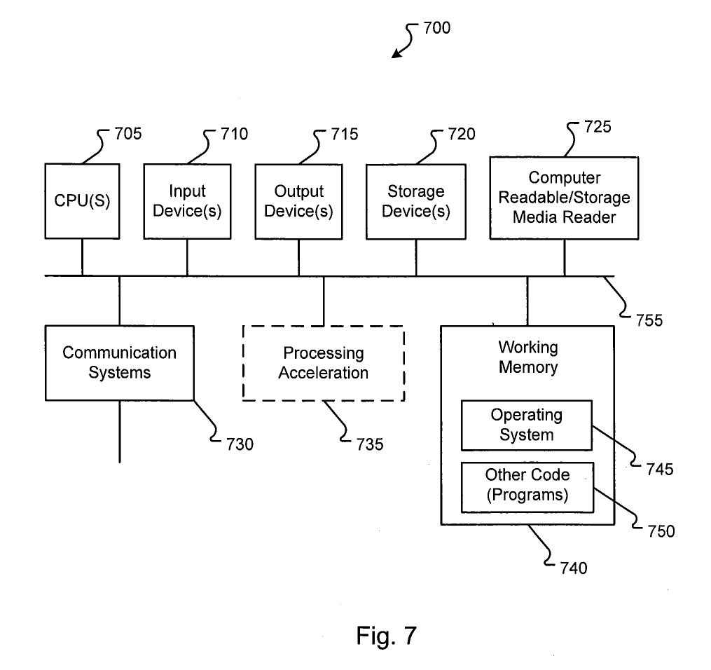

FIG. 7 illustrates one embodiment of a computer system 700 upon which the servers, computers, or other systems or components described herein may be deployed or executed. The computer system 700 is shown comprising hardware elements that may be electrically coupled via a bus 755. The hardware elements may include one or more central processing units (CPUs) 705; one or more input devices 710 (e.g., a mouse, a keyboard, etc.); and one or more output devices 715 (e.g., a display device, a printer, etc.). The computer system 700 may also include one or more storage devices 720. By way of example, storage device(s) 720 may be disk drives, optical storage devices, solid-state storage devices such as a random access memory (“RAM”) and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735, which can include a DSP, a special-purpose processor, and/or the like.

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with the network 720 and/or any other computer described above with respect to the system 700. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 700 may also comprise software elements, shown as being currently located within a working memory 740, including an operating system 745 and/or other code 750. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not, to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments have been described in detail herein, it is to be understood that the inventive concepts may be otherwise variously embodied and employed, and that the appended claims are intended to be construed to include such variations, except as limited by the prior art.

What is claimed is:

1. A method for responding to an event associated with geo-location information, the method comprising:
a processor receiving geo-location information for a first person;
the processor identifying the first person;
the processor determining a status associated with the first person;
the processor determining an event rule associated with the first person and the status associated with the first person;
the processor applying the event rule;
the processor determining an action to be conducted in response to applying the event rule; and
the processor sending an indication to cause the action to be conducted.

2. The method as defined in claim 1, wherein the status is one of a group consisting of furlough, leave, closure, sabbatical, holiday, and vacation.

3. The method as defined in claim 1, wherein the geo-location information comprises an identity for the first person and wherein identifying the first person comprises one of direct identification, indirect identification, determining an association for the first person, or locating the identity in an personal data database.

4. The method as defined in claim 3, wherein determining the status associated with the first person comprises in response to locating the identity of the first person in the enterprise directory, retrieving the status associated with the first person associated with the identity as stored within the enterprise directory.

5. The method as defined in claim 1, wherein the event rule is created by an enterprise.

6. The method as defined in claim 1, wherein applying the event rule comprises:
a decision support system retrieving at least one item of information about the first person;
the decision support system inserting the item of information and the status associated with the first person into the event rule; and
the decision support system calculating an outcome for the event rule.

7. The method as defined in claim 6, wherein the action is one of a group consisting of denying the first person access to a location associated with an enterprise, denying the first person access to a system associated with an enterprise, disabling a device, denying the first person operation of a system associated with an enterprise, denying operation of a system without the first person located at a location, sending a message to at least a second person to respond to a status associated with the first person, and alerting the first person of an obligation.

8. A computer readable medium having stored thereon instructions that cause a computer to execute a method for conducting an action associated with a geo-location, the instructions comprising:
instructions to receive geo-location information for at least a first person and a second person;
instructions to identify the first person and the second person;
instructions to determine a relationship between the first person and the second person;
instructions to determine an event rule associated with the first person and the second person;
instructions to apply the event rule;
instructions to determine an action to conduct in response to applying the event rule; and
instructions to cause the action to be conducted, wherein the action requires a reaction by the second person in response to the status associated with the first person.

9. The computer readable medium as defined in claim 8, wherein the status is one of a group consisting of furlough, leave, closure, sabbatical, holiday, and vacation.

10. The computer readable medium as defined in claim 9, wherein the action is one of a group consisting of assuming the duties of the first person for a period of time, waiting for the first person at a location before conducting an action, responding to an alert caused by the first person, retrieving an item of property associated with the first person, and locating the first person to provide assistance.

11. The computer readable medium as defined in claim 8, wherein the first person and second person are members of a geo-pod.

12. The computer readable medium as defined in claim 8, further comprising instructions to determine a second status for the second person.

13. The computer readable medium as defined in claim 8, further comprising:
instructions to apply a second event rule, wherein the second event rule is associated with the status associated with the second person and the status associated with the first person;
instructions to determine a second action to conduct in response to applying the second event rule; and
instructions to conduct the second action, wherein the second action requires a response by a third person.

14. An interaction center system for an enterprise comprising:
a geo location service operable to provide geo location information for at least one person;
an enterprise server operable to provide personal information about at least one person and operable to provide at least one event rule associated with the person;
an interaction center server in communication with the geo location service and the enterprise server, the interaction center server operable to:
receive geo-location information for a first person associated with the enterprise;
identify the first person associated with the geo-location information;
provide an identity of the first person to the enterprise server;
in response to sending the identity of the first person to the enterprise server, receive the personal information from the enterprise server, wherein a status associated with the first person is part of the personal information;
in response to sending the identity of the first person to the enterprise server, receive an event rule associated with the first person from the enterprise server;
apply the event rule with the status and the geo-location information;
in response to applying the event rule, determine an action to be conducted; and
sending an indication that causes the action to be conducted.

15. The interaction center system as defined in claim 14, further comprising an enterprise data database in communication with the enterprise server, the enterprise data database operable to store personal information about the first person.

16. The interaction center system as defined in claim 14, wherein the interaction center server is further operable to:
receive geo-location information for a second person associated with the enterprise, wherein the first person and the second person are part of a geo-pod;
identify the second person associated with the geo-location information;
provide an identity of the second person to the enterprise server;
in response to sending the identity of the second person to the enterprise server, receive a second set of personal information from the enterprise server for the second person, wherein a status associated with the second person is part of the personal information;
in response to sending the identity of the second person to the enterprise server, receive an event rule associated with the first person and the second person;
apply the event rule with the status and the geo-location information;
in response to applying the rule, determine an action to conduct; and
conduct the action.

17. The interaction center system as defined in claim 14, wherein the interaction center server comprises:
a decision support system, the decision support system executing:
a person identifier module operable to identify the first person;
an action identifier module operable to identify an action to conduct;
a user application operable to send and received information with the enterprise server and operable to determine the event rule to apply; and
a work flow engine in communication with the person identifier module, action identifier module, and user application, the work flow engine operable to conduct the action, wherein the work flow engine conducts the action by at least communicating with a communication device.

18. The interaction center system as defined in claim 14, wherein the enterprise server is in communication with at least one of a personal data database, an enterprise policies database, and a historical data database.

19. The interaction center system as defined in claim 18, wherein the enterprise policies database includes a grammar associated with the event rule, wherein the interaction center server can apply the grammar to at least the geo-location information.

20. The interaction center system as defined in claim 18, wherein the personal data includes a person ID, a user preference that sets a parameter for the interaction center server, user information, and a user status.
